(19) United States
(12) Patent Application Publication
(10) Pub. No.: US 2004/0141222 A1
(43) Pub. Date: Jul. 22, 2004

(54) Optical phase multi-level modulation method and apparatus, and error control method

(75) Inventors: Tetsuya Miyazaki, Tokyo (JP); Kazuro Kikuchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Communications Res. Lab., Ind. Admin. Inst., Koganei-shi (JP)

(21) Appl. No.: 10/697,117

(22) Filed: Oct. 31, 2003

(30) Foreign Application Priority Data
Nov. 1, 2002 (JP) 2002-320341

(51) Int. Cl. G02F 1/00

(52) U.S. Cl. 359/237

(57) ABSTRACT

A phase modulation method and apparatus use a plurality of phase modulators disposed in series to phase-modulate light from a source laser. Modulation by the phase modulators is used to produce phase shifts in the optical signal, with modulation by the first phase modulator producing phase shifts of 0 degrees or 2φ degrees, and modulation by the n-th phase modulator producing phase shifts of 0 degrees or 2ⁿ×φ degrees. Here, φ degrees is a predetermined phase level and n is an integer than two and not more than the number of phase modulators. The method is also used to detect and control transmission errors.

### BACKGROUND OF THE INVENTION

1. Field of the Invention

The present invention relates to an optical phase multi-level modulation method and apparatus used in optical carrier wave based digital communications for the transmission of symbols, and to an error control method using the optical phase multi-level modulation method.

2. Description of the Prior Art

Methods employed for the digital communication of electric transmission signals include Phase Shift Keying (ASK) methods such as Binary Phase Shift Keying (BPSK), Quadrature Phase Shift Keying (QPSK) and Differential Quadrature Phase Shift Keying (DQPSK).

In general, PSK systems are not used in optical carrier wave based digital communications. However, “10 Gb/s Optical Differential Quadrature Phase Shift Key (DQPSK) Transmission using GaAs/AlGaAs Integrations” by R. A. Griffin, et al., (FD6, OFC 2002 post-deadline papers), describes DQPSK based optical communication. FIG. 9 illustrates the configuration of the system described in the reference. On the encoder side, a laser beam from a laser diode is modulated with an optical modulator having a Mach-Zhender superstructure. The laser beam is split along two paths. The beam of one path is modulated by the I (in-phase) component of the modulating signal, and the beam of the other is modulated by the Q (quadrature) component, advancing the carrier phase 90 degrees. The two beams are then combined for transmission. On the decorder side, the transmitted beam thus received is split along two paths, the beam of one of which is phase-shifted 45 degrees and, after delayed detection, is converted to an electric signal by a balanced detector, demodulating the I- and Q-component signals. The other beam is phased-shifted −45 degrees and, after delayed detection, is converted to an electric signal by a balanced detector, demodulating the remaining component.

In the case of the above configuration, in addition to an I-component modulator and a Q-component modulator, a configuration is required for advancing the carrier phase 90 degrees. While the present invention uses an I-component modulator and a Q-component modulator, it differs from the above reference configuration in that it does not require an arrangement for advancing the carrier phase 90degrees.

Also, while there are conventional configurations in which a plurality of optical phase modulators is arranged in series on a single optical path, the prior art does not include a configuration that, with respect to the modulation effect of each of the serially disposed modulators, has a modulating effect on each of the binary digital positions. Also unknown in the prior art is the arrangement of two phase-modulators in series in which one modulator uses I-component quadrature modulation and the other modulator uses Q-component quadrature modulation.

In the above digital modulation, each of the phase modulators performs binary modulation. However, it can be readily understood that such modulation can also be used to produce an optical modulated signal by using a single modulator to effect phase modulation by means of a multi-level digital signal. However, this modulation method requires a digital-analogue conversion circuit, which does not operate at a high enough speed for it to be efficiently applicable for high-speed data communications. Thus, in optical communications using a conventional DQPSK method, optical modulation is performed with optical modulators having a Mach-Zhender superstructure, which requires numerous optical components.

In view of the above, an object of the present invention is to provide an optical phase multi-level modulation method and apparatus, and an error control method using the same.

### SUMMARY OF THE INVENTION

The method of the present invention in which a light from a source laser is phase modulated by a plurality of phase modulators disposed in series, comprises, when φ degrees is a predetermined phase value and n is an integer that is not less than three and not more than the number of phase modulators, phase modulation by a first phase modulator that produces phase shifts of 0 degrees or 2φ degrees, phase modulation by a second phase modulator that produces phase shifts of 0 degrees or 2²φ degrees, and phase modulation by an n-th phase modulator that produces phase shifts of 0 degrees or 2ⁿφ degrees.

If the angular velocity of the carrier wave is 2πω, when the amplitude is normalized, with the QPSK method, the in-phase-component modulated wave outputs will be cos(2 πωt) and −cos(2 πωt) and the quadrature-component modulated wave outputs will be sin(2 πωt) and −sin(2 πωt). The two modulated waves will be output superposed, so the transmitted modulated waves can be expressed, respectively, as cos(2 πωt+π/4), cos(2 πωt+3π/4), cos(2 πωt+5π/4) and cos(2 πωt+7π/4), it being known that there is a phase differential of π/2.

Thus, to attain the above object, the present invention provides a phase modulation method comprising using a plurality of phase modulators disposed in series to phase modulate a light from a source laser, wherein modulation by a first phase modulator is phase modulation that produces phase shifts of 0 degrees or 2φ degrees, and modulation by an n-th phase modulator is phase modulation that produces phase shifts of 0 degrees or 2ⁿ×φ degrees, φ degrees being a predetermined phase value and n an integer that is not less than two and not more than the number of phase modulators.

The method also includes an optical phase multi-level modulation method comprising using first and second phase modulators disposed in series to phase modulate a light from a source laser, wherein modulation by the first phase modulator is modulation by an in-phase component of quadrature modulation, and modulation by the second phase modulator is modulation by a quadrature component of quadrature modulation.

The method also includes an optical phase multi-level modulation method comprising using first and second phase modulators disposed in series to phase modulate a light from a source laser, wherein modulation by the first phase modulator is modulation that produces phase shifts of 0 degrees or 180 degrees, and modulation by the second phase modulator is modulation that produces phase shifts of 0 degrees or 90 degrees.

The method also includes an optical phase multi-level modulation method comprising using first and second phase modulators disposed in series to phase modulate a light from a source laser, wherein modulation by the first phase modulator is modulation by an in-phase component of quadrature modulation that produces phase shifts of 0degrees or 180 degrees, and modulation by the second phase modulator is modulation by a quadrature component of quadrature modulation that produces phase shifts of 0 degrees or 90 degrees.

The method also includes an optical phase multi-level modulation method comprising using first and second phase modulators disposed in series to phase modulate a light from a source laser, wherein modulation by the first phase modulator is modulation by an in-phase component of quadrature modulation that produces phase shifts of 0 degrees or 90 degrees, and modulation by the second phase modulator is modulation by a quadrature component of quadrature modulation that produces phase shifts of 0 degrees or 180 degrees.

The object is also attained by an optical phase multi-level modulation apparatus comprising a laser light source and a plurality of phase modulators disposed in a series configuration in which a light from the laser light source is modulated by a first phase modulator that produces phase shifts of 0 degrees or 2φ degrees, and is modulated by an n-th phase modulator that produces phase shifts of 0 degrees or 2ⁿ×φ degrees, φ degrees being a predetermined phase value and n an integer that is not less than two and not more than the numb r of phase modulators.

The apparatus also includes one comprising a laser light source, first and second phase modulators disposed in series, and means for outputting in-phase and quadrature components of quadrature modulation, in which a light from the laser light source is modulated in the first phase modulator by an in-phase component of quadrature modulation, and is modulated in the second phase modulator by a quadrature component of quadrature modulation.

The apparatus also includes one comprising a laser light source, first and second phase modulators disposed in series, and means for outputting in-phase and quadrature components of quadrature modulation, in which light from the laser light source modulated in the first phase modulator is phase-shifted 0 degrees or 180 degrees, and light modulated in the second phase modulator is phase-shifted 0 degrees or 90 degrees.

The apparatus also includes one comprising a laser light source, first and second phase modulators disposed in series, and means for outputting in-phase and quadrature components of quadrature modulation, in which a light from the laser light source is modulated in the first phase modulator by an in-phase component of quadrature modulation that produces phase shifts of 0 degrees or 180 degrees, and is modulated in the second phase modulator by a quadrature component of quadrature modulation that produces phase shifts of 0 degrees or 90 degrees.

The apparatus also includes one comprising a laser light source, first and second phase modulators disposed in series, and means for outputting in-phase and quadrature components of quadrature modulation, in which a light from the laser light source is modulated in the first phase modulator by an in-phase component of quadrature modulation that produces phase shifts of 0 degrees or 90 degrees, and is modulated in the second phase modulator by a quadrature component of quadrature modulation that produces phase shifts of 0 degrees or 180 degrees.

The object is also attained by an error control method that detects and controls errors on a bit-by-bit basis, comprising using the optical phase multi-level modulation method on the sending side to transmit the laser light signal modulated by quadrature modulation in-phase and quadrature components containing some of the same symbols as the respective information signals, and on the receiving side confirms whether or not the logical levels of the decoded signals are the same.

The error control method also includes one in which, for the confirmation, logical levels provided for the quadrature and in-phase components are used to determine whether a state of said components is high (H) or low (L), with a determination only being used if it matches the component determination outcome concerned (H or L).

The error control method also includes one in which, on the receiving side, symbols included in the in-phase and quadrature components which are the same are given different delay times to cancel delay time differences between symbols included in the in-phase and quadrature components that are the same.

Thus, as described in the foregoing, a plurality of phase modulators is used for distributed modulation of digital data, which makes it possible to reduce the upper limit on the frequency band requirements of each phase modulator. Also, modulation is performed using two phase modulators arranged in series, which enables quadrature modulation using a simple system configuration. In addition, the quadrature and in-phase components of quadrature modulation are used for bit-by-bit error control, making it possible to improve the reliability of optical communications.

### BRIEF EXPLANATION OF THE DRAWINGS

FIG. 1 is a block diagram showing a first example of an embodiment of the optical phase multi-level modulation apparatus of the invention.

FIG. 2(a) shows an example of a digital signal to be transmitted.

FIG. 2(b) shows an example of a digital signal train extracted from odd-numbered digital signals to be sent.

FIG. 2(c) shows an example of a digital signal train extracted from even-numbered digital signals to be sent.

FIG. 2(d) shows a received wave that has been phase-modulated.

FIG. 3 is a block diagram showing a second example of an embodiment of the optical phase multi-level modulation apparatus of the invention.

FIG. 4 is a block diagram of the demodulator used to demodulate the modulated wave.

FIG. 5 is a block diagram showing a third example of an embodiment of the optical phase multi-level modulation apparatus of the invention.

FIG. 6 is a block diagram showing the delay units, phase-shifters and detectors used in the apparatus of the third example.

FIG. 7 is a block diagram showing the entire configuration of the optical multi-level modulation apparatus according to the third example of the embodiment of the present invention.

FIG. 8 is a block diagram of a selection circuit.

FIG. 9 is a block diagram of an optical quadrature modulation configuration according to the prior art.

### DESCRIPTION OF THE PREFERRED EMBODIMENT

Details of the embodiment of the invention will now be described with reference to the drawings. In the explanation, parts having the same or similar functions are given the same reference symbols, unless otherwise stated.

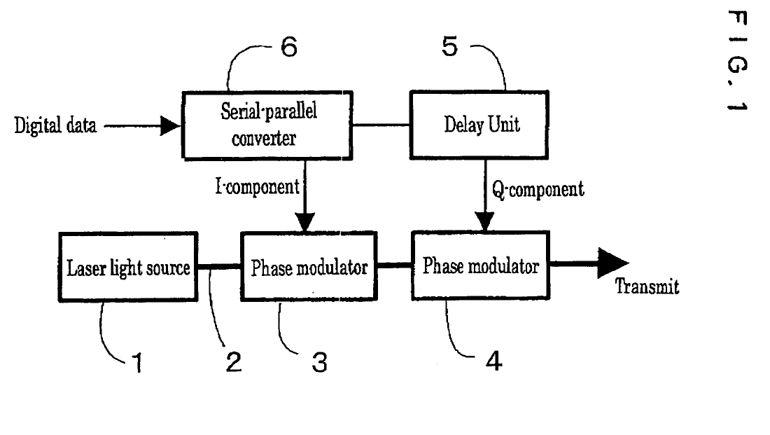

To start with, an example of the invention will be described with reference to FIG. 1, which is a block diagram showing the configuration of the optical phase multi-level modulation apparatus. A conventional serial-parallel converter 6 divides input digital data into 2-bit data, with one bit being output as an I (in-phase) component and the other bit being output as a Q (quadrature) component. An optical modulator 3 on the optical path 2 uses the I-component to modulate the light beam from a laser light source 1. An optical modulator 4 uses the Q-component to modulate the beam. The beam is delayed by its passage through the optical modulator 3, so to compensate, the Q-component signal is delayed with a delay unit 5. The output from the optical modulator 4 goes to the transmission path it is to be understood that the 2-bit data can be classified into Q and I-component data instead of I- and Q-component data, as in the above case.

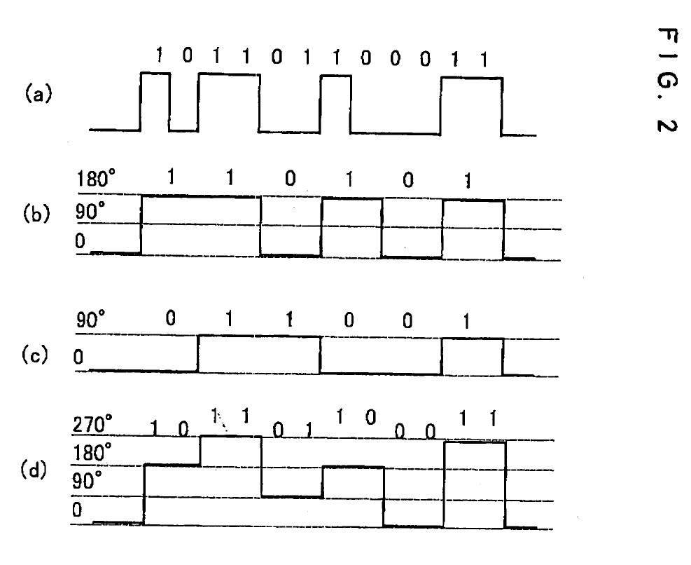

The amount of phase shift imparted by the optical modulators 3 and 4 will now be explained. FIG. 2(a) shows an example of a digital signal to be transmitted, and FIG. 2(b) shows an example of a digital signal train extracted from odd-numbered digital signals to be sent. When the I-component signal is 1, the phase is shifted 180 degrees, and when the signal is 0, there is no phase shift FIG. 2(c) shows an example of a digital signal train extracted from even-numbered digital signals to be sent, a Q-component in this case. When the Q-component signal is 1, the phase is shifted 90 degrees, and when the signal is 0, there is no phase shift. These phase modulations are carried out using the phase modulators 3 and 4 connected in series. Light passing through the phase modulators receives phase modulation depicted in FIG. 2(d). The transmitted wave signal modulated by the two phase modulators connected in series can be denoted as cos(2 πωt), cos(2 πωt+π/2), cos(2 πωt+π) and cos(2 πωt+3π/2). There is a phase difference of π/4=45 degrees with respect to the modulated wave obtained by the quadrature modulation of the prior art described above, which does not pose an obstacle to demodulation.

By using two phase-modulators connected in series to effect phase modulation, the frequency bandwidth required by the phase modulators is half that required in the case of phase modulation using a single phase modulator, so the phase modulator configuration can be simplified. The structure is also simplified by not having to provide a section to effect the π/2=90 degree phase shift provided in an optical modulator with a Mach-Zhender superstructure.

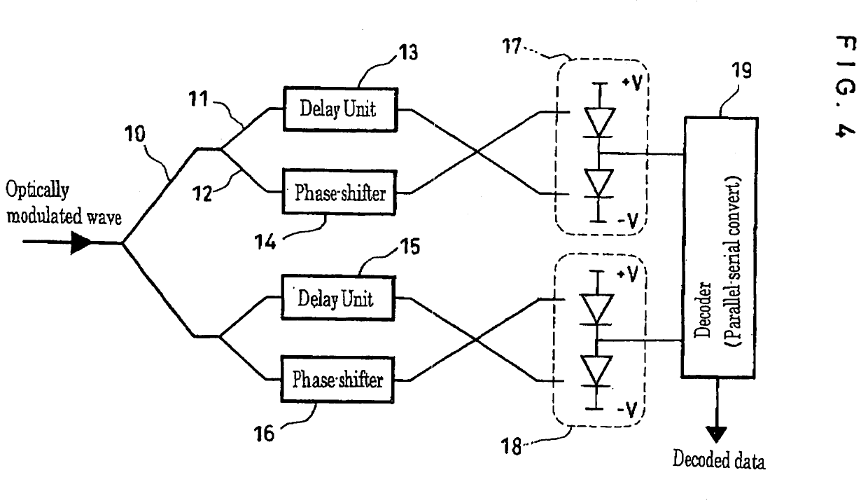

The phase-modulated wave of FIG. 2(d) transmitted along the transmission path is demodulated with a demodulator. FIG. 4 is a block diagram of a demodulator that can be used for the demodulation. As is well known, the demodulator splits the received lightwave along two optical paths. For example, path 10 is split into optical path 11 and optical path 12, a one-bit delay is imparted to the light on the path 11, the light on the path 12 is phase-shifted 45 degrees, and delay detection is effected by combining the light of the paths 11 and 12. Next, the light is converted to an electric signal by a balanced detector 17 to demodulate the I- and Q-component signals. In the same way, the light on the other path is phase-shifted 45 degrees, and after delay detection is converted to an electric signal by a balanced detector 18 to demodulate the remaining component. Here, it is essential to provide a phase difference of 90 degrees between the phase-shift amounts imparted by the phase-shifter 14 and phase-shifter 16. However, the absolute amount of the phase-shift is an arbitrary value and should be set from the standpoint of convenience and simplicity of the system apparatus. Demodulated I- and Q-component signals are converted from parallel to serial data by a decoder 19.

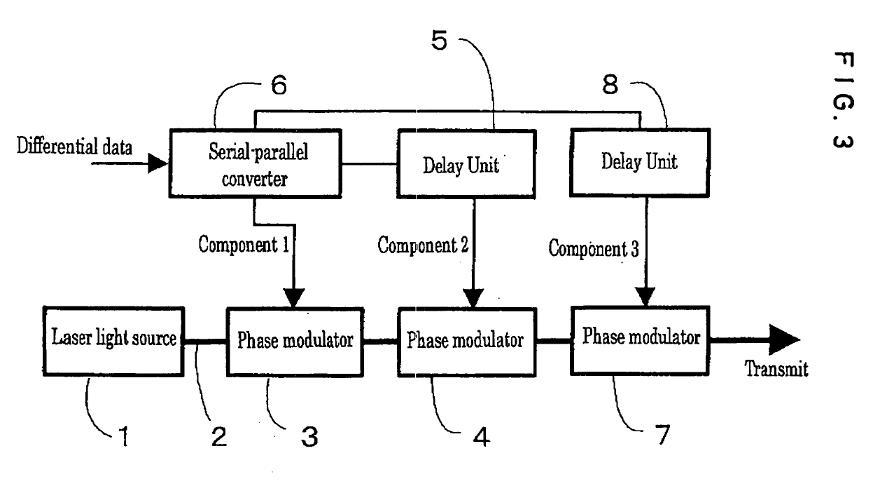

In the above explanation, four degrees of phase-shift are effected by the phase modulators. However, the optical phase multi-level modulation apparatus shown in FIG. 3 can provide phase-shift in more numerous amounts. The serial-parallel converter in FIG. 3 continuously converts digital data to 3-bit data strings at a one-bit time series. The first bit of the data sequence is modulated with the phase modulator 3 and the second bit with the phase modulator 4. Simultaneously, the third bit data sequence is modulated with phase modulator 7. In this modulation, there is a phase-shift of 0 or φ₁ degrees at the phase modulator 3, 0 or φ₂ degrees at the phase modulator 4 and 0 or φ₃ degrees at the phase modulator 7. φ₁ φ₂ and φ₃ should each be different levels, with φ₂=2×φ₁φ₃=2×φ₂. When more modulation stages are used, this method is extended to satisfy the relationship φₖ =2×φₖ₋₁. Moreover, a known multi-level phase discriminator can be used for demodulating lightwaves optically modulated using more than four phase-shift amounts applied by the phase modulators, as mentioned above.

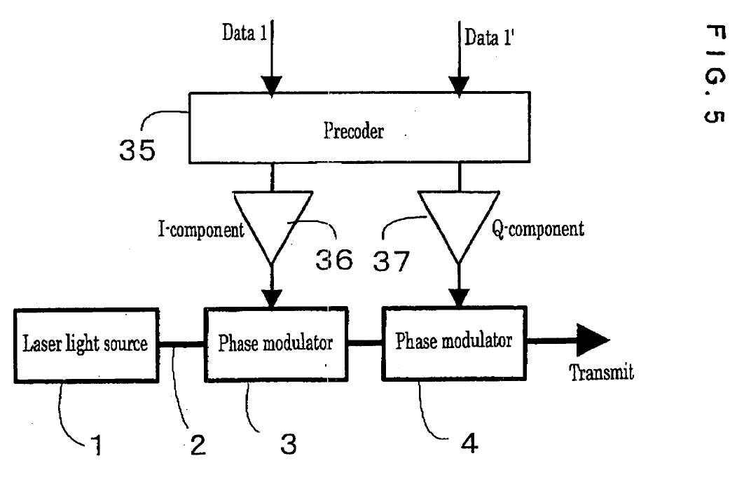

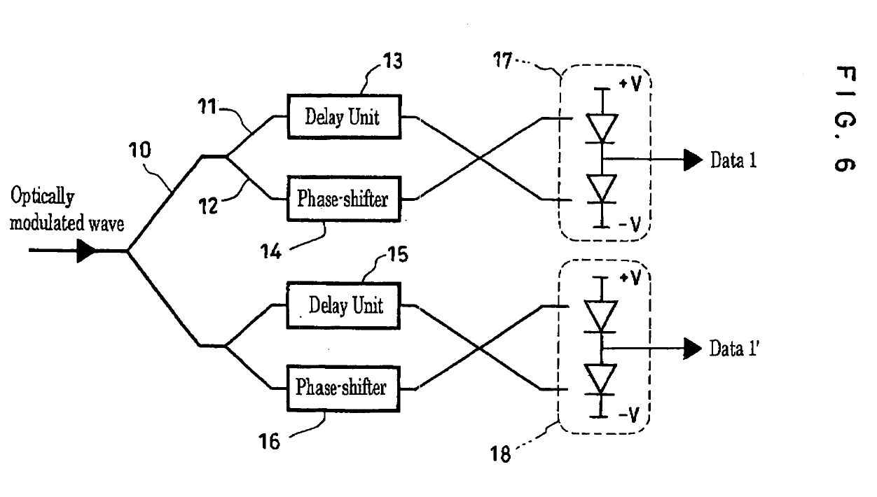

bit-by-bit error detection and control can be effected by transmitting an optical signal with the addition of a signal that is the same as that output by the optical modulators 3 and 4 of FIG. 5, as explained below. Here, it is assumed that data 1 and data 1′ shown in FIG. 5 have a shared signal region. From these signals, a precoder 35 generates I- and Q-components that are applied to the respective phase modulators 3 and 4, which phase-modulate the light from the laser light source 1 and transmits it along the optical path.

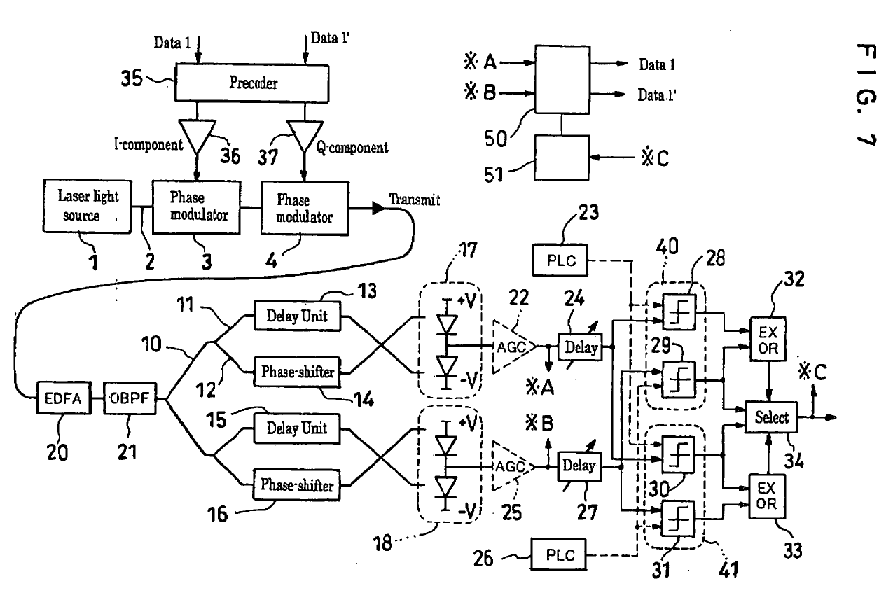

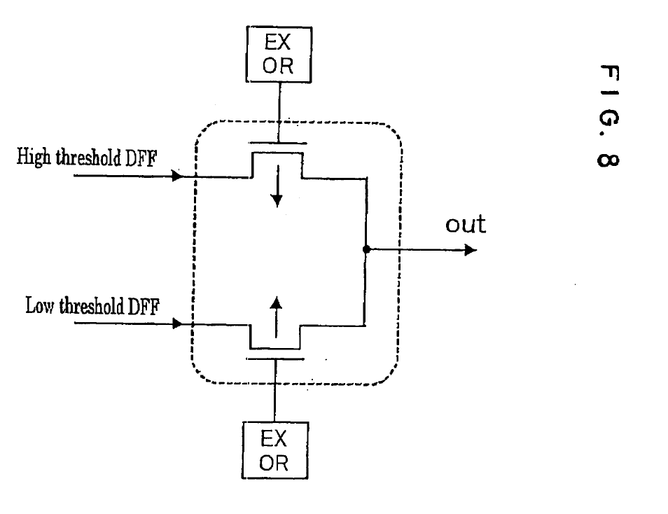

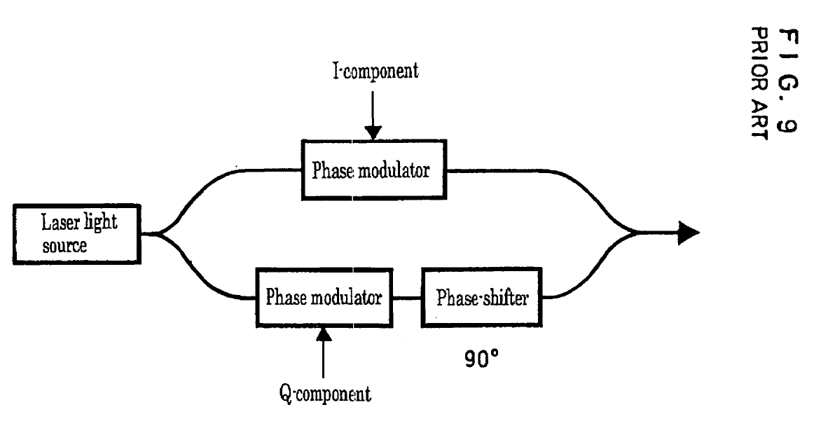

On the receiving side, as shown in FIG. 7, the optical signal is amplified by optical amplifier 20 and passed through an optical bandpass filter 21 to obtain the required optical signal. Using a demodulator similar to the one shown in FIG. 4, the optical signal is then converted to electric signals by the balanced detector 17 or 18, thereby effecting I- and Q-component signal demodulation. If there are no transmission errors caused by line noise or the like, these signals should correspond to the data 1 and data 1′. The output from the balanced detector 17 is passed through an automatic gain control (AGC) circuit 22 to suppress amplitude fluctuations, given a time delay by delay unit 24 and is then input to a D-latch circuit 28 having a high-threshold level DFF 40 and a D-latch circuit 30 having a low-threshold level DFF 41. Similarly, the output from the balanced detector 18 is passed through an automatic gain control (AGC) circuit 25 to suppress amplitude fluctuations, given a time delay by delay unit 27 and is then input to a D-latch circuit 29 having a high-threshold level DFF 40 and a D-latch circuit 31 having a low-threshold level DFF 41. The delay units 24 and 27 are used for adjustments to eliminate delays between common signals included in the I- and Q-components. The delay time is usually imparted by means of the delay units by locating the circuits appropriately. However, even when delay differences are aggressively reduced on the transmitting side, they can be used on the demodulation side to eliminate delay differences. The operation of eliminating delay time differentials involves comparing the common signals included in the I- and Q-components, as described below.

The high-threshold level DFF 40 is supplied by a programmed level controller 23 to enable the D-latch circuits 28 and 29 to determine whether a logical level is in a high state (H) or a low (L) state. The PLC regulates the logical level according to the signal amplitude. When the level is determined to be H, circuit 28 or 29 outputs a 1. The low-threshold level DFF 41 is supplied by means of a programmed level controller 26 to enable the D-latch circuits 30 and 31 to determine whether a logical level is in a high (H), medium (M) or low (L) state. The PLC regulates the logical level according to the signal amplitude. When the level is determined to be L, circuit 30 or 31 outputs a 0. The PLC can also be configured to determine between just H and L states.

The output by D-latch circuit 28 or 29 goes to an exclusive OR (EXOR) circuit 33, and a 0 is output only if it matches the output from the D-latch circuit 30 or 31. In this case, a selection circuit 34 selects the DFF 40 output. Thus, only when the decoded results of the two systems match is the result utilized, thereby enabling bit-by-bit error detection and correction.

As described, the output from the selection circuit 34 is used for error correction. Specifically, it is used for control by a controller 51 to reduce error. The controller 51 controls a switcher 50, which receives signals from AGCs 22 and 23 and from the controller 51 and controls the output of data 1 and data 1′, or controls the output from the selection circuit 34 to the data 1 side or the data 1′ side. When transmission line conditions are good and there are no errors, so no need for error control, the data 1 and data 1′ are output to provide effective transmission. In such a case, it is not essential for data 1 and data 1′ to include the same contents.

Using a plurality of phase modulators for distributed modulation of digital data makes it possible to reduce the upper limit on the frequency band requirements of each phase modulator. Also, modulation is performed using two phase modulators arranged in series, which enables quadrature modulation using a simple system configuration. In addition, the quadrature and in-phase components of quadrature modulation are used for bit-by-bit error control, making it possible to improve the reliability of optical communications.

What is claimed is:

1. A phase modulation method comprising:
using a plurality of phase modulators disposed in series to phase modulate light from a source laser,
wherein modulation by a first phase modulator is phase modulation that produces phase shifts of 0 degrees or 2φ degrees, and
modulation by an n-th phase modulator is phase modulation that produces phase shifts of 0 degrees or 2ⁿ×φ degrees, φ degrees being a predetermined phase level and n an integer that is not less than two and not more than the number of phase modulators.

2. An optical phase multi-level modulation method comprising:
using first and second phase modulators disposed in series to phase modulate a light from a source laser,
wherein modulation by the first phase modulator is modulation by an in-phase component of quadrature modulation, and
modulation by the second phase modulator is modulation by a quadrature component of quadrature modulation.

3. An optical phase multi-level modulation method comprising:
using first and second phase modulators disposed in series to phase modulate a light from a source laser,
wherein modulation by the first phase modulator is modulation that produces phase shifts of 0 degrees or 180 degrees, and
modulation by the second phase modulator is modulation that produces phase shifts of 0 degrees or 90 degrees.

4. An optical phase multi-level modulation method comprising;
using first and second phase modulators disposed in series to phase modulate a light from a source laser,
wherein modulation by the first phase modulator is modulation by an in-phase component of quadrature modulation that produces phase shifts of 0 degrees or 180 degrees, and
modulation by the second phase modulator is modulation by a quadrature component of quadrature modulation that produces phase shifts of 0 degrees or 90 degrees.

5. An optical phase multi-level modulation method comprising:
using first and second phase modulators disposed in series to phase modulate a light from a source laser,
wherein modulation by the first phase modulator is modulation by an in-phase component of quadrature modulation that produces phase shifts of 0 degrees or 90 degrees, and
modulation by the second phase modulator is modulation by a quadrature component of quadrature modulation that produces phase shifts of 0 degrees or 180 degrees.

6. An optical phase multi-level modulation apparatus comprising: a laser light source and a plurality of phase modulators disposed in a series configuration in which a light from the laser light source is modulated by a first phase modulator that produces phase shifts of 0 degrees or 2φ degrees, and is modulated by an n-th phase modulator that produces phase shifts of 0 degrees or 2ⁿ×φ degrees, φ degrees being a predetermined phase level and n an integer that is not less than two and not more than the number of phase modulators.

7. An optical phase multi-level modulation apparatus comprising: a laser light source, first and second phase modulators disposed in series, and means for outputting in-phase and quadrature components of quadrature modulation, in which a light from the laser light source is modulated in the first phase modulator by an in-phase component of quadrature modulation, and is modulated in the second phase modulator by a quadrature component of quadrature modulation.

8. An optical phase multi-level modulation apparatus comprising: a laser light source, first and second phase modulators disposed in series, and means for outputting in-phase and quadrature components of quadrature modulation, in which light from the laser light source modulated in the first phase modulator is phase-shifted 0 degrees or 180 degrees, and light modulated in the second phase modulator is phase-shifted 0 degrees or 90 degrees.

9. An optical phase multi-level modulation apparatus comprising: a laser light source, first and second phase modulators disposed in series, and means for outputting in-phase and quadrature components of quadrature modulation, in which a light from the laser light source is modulated in the first phase modulator by an in-phase component of quadrature modulation that produces phase shifts of 0 degrees or 180 degrees, and is modulated in the second phase modulator by a quadrature component of quadrature modulation that produces phase shifts of 0 degrees or 90 degrees.

10. An optical phase multi-level modulation apparatus comprising: a laser light source, first and second phase modulators disposed in series, and means for outputting in-phase and quadrature components of quadrature modulation, in which a light from the laser light source is modulated in the first phase modulator by an in-phase component of quadrature modulation that produces phase shifts of 0 degrees or 90 degrees, and is modulated in the second phase modulator by a quadrature component of quadrature modulation that produces phase shifts of 0 degree or 180 degrees.

11. An error control method that detects and controls errors on a bit-by-bit basis, comprising using the optical phase multi-level modulation method according to claim 2 on a sending side to transmit the laser light signal modulated by quadrature modulation in-phase and quadrature components containing some of the same symbols as the respective information signals, and on a receiving side confirms whether or not the logical lev is of the decoded signals are the same.

12. The error control method according to claim 11, in which, in said confirmation, logical levels provided for the quadrature and in-phase components are used to determine whether a state of said components is high (H) or low (L), with a determination only being used if it matches the component determination outcome concerned (H, M or L).

13. The error control method according to claim 12, in which, on a receiving side, symbols included in the in-house and quadrature components that are the same are given different delay times to cancel delay time differences between symbols included in the in-house and quadrature components that are the same.
